(19) United States
(12) Patent Application Publication
(10) Pub. No.: US 2025/0329149 A1
(43) Pub. Date: Oct. 23, 2025

(54) LEARNING DEVICE, LEARNING METHOD, AND IMAGE SEGMENTATION DEVICE

(71) Applicant: Mitsubishi Electric Corporation, Tokyo (JP)

(72) Inventor: Yoshihiro TOMARU, Tokyo (JP)

(73) Assignee: Mitsubishi Electric Corporation, Tokyo (JP)

(21) Appl. No.: 19/256,977

(22) Filed: Jul. 1, 2025

Related U.S. Application Data
(63) Continuation of application No. PCT/JP2023/007448, filed on Mar. 1, 2023.

(51) Int. Cl. G06V 10/776; G06T 7/12; G06V 10/82

(52) U.S. Cl. CPC G06V 10/776; G06T 7/12; G06V 10/82

(57) ABSTRACT

There are included: a learning data acquiring unit to acquire learning data that is a combination of a learning image, a correct edge image indicating a correct edge in the learning image, and a correct geometric parameter related to a shape of the correct edge; an edge estimating unit including a neural network to output an estimated edge image indicating an estimated edge of the learning image and an estimated geometric parameter related to a shape of the estimated edge by inputting the learning image to the neural network; a cost calculating unit to calculate a cost for evaluating estimation accuracy by the edge estimating unit by using the correct edge image, the correct geometric parameter, the estimated edge image, and the estimated geometric parameter; and a model parameter updating unit to update a model parameter in the neural network by using the cost calculated by the cost calculating unit.

### CROSS REFERENCE TO RELATED APPLICATION

This application is a Continuation of PCT International Application No. PCT/JP2023/007448, filed on Mar. 1, 2023, which is hereby expressly incorporated by reference into the present application.

### TECHNICAL FIELD

The present disclosure technology relates to a technique of image segmentation.

### BACKGROUND ART

Image segmentation is one of image recognition techniques, and is a technique for identifying what each pixel of an image belongs to and dividing the image for each identified attribute.

Among the image segmentation, there is a technique of extracting a feature by inputting an image to a neural network and detecting a position, a contour, and a region on the basis of the feature.

For example, Patent Literature 1 discloses image segmentation in which a pixel estimation stream that is a neural network that performs class identification (for example, class identification such as contour or non-contour) in a general pixel unit and a feature estimation stream that is a neural network that extracts features (for example, features such as people, cars and trees) of any region are combined. According to the image segmentation described in Patent Literature 1, “it is possible to obtain a more accurate contour and region of a person by giving, to the pixel estimation stream, approximate position information of the person detected in the feature estimation stream for an input image in which the person appears. On the other hand, it is possible to more accurately obtain the position of the person by giving an approximate contour and region of a person detected in the pixel estimation stream to the feature estimation stream.” (paragraph of Patent Literature 1)

### CITATION LIST

### Patent Literatures

Patent Literature 1: JP 2019-101519 A

### SUMMARY OF INVENTION

### Technical Problem

However, in the image segmentation described in Patent Literature 1, for example, an edge of an estimation result may be distorted in a zigzag shape although the segmentation target is actually a linear contour (edge).

That is, the image segmentation described in Patent Literature 1 has a problem that estimation accuracy of the image segmentation is low.

The present disclosure solves the above problem, and an object thereof is to improve estimation accuracy of image segmentation.

### Solution to Problem

A learning device of the present disclosure includes:
a processor; and
a memory storing a program, upon executed by the processor, to perform a process:
to acquire learning data that is a combination of a learning image, a correct edge image indicating a correct edge of the learning image, and a correct geometric parameter related to a shape of the correct edge;
using a neural network to output an estimated edge image indicating an estimated edge of the learning image and an estimated geometric parameter related to a shape of the estimated edge by inputting the learning image to the neural network;
to calculate a cost for evaluating estimation accuracy by using the correct edge image, the correct geometric parameter, the estimated edge image, and the estimated geometric parameter; and to update a model parameter of the neural network by using the cost calculated.

### Advantageous Effects of Invention

According to the present disclosure, it is possible to improve estimation accuracy of image segmentation.

### BRIEF DESCRIPTION OF DRAWINGS

FIG. 1 is a diagram illustrating an example of a configuration according to a first embodiment of the present disclosure.

FIG. 2 is a diagram illustrating an example of learning data 1000 used in the first embodiment of the present disclosure.

FIG. 3 is a flowchart illustrating an example of processing by the configuration according to the first embodiment of the present disclosure.

FIGS. 4A and 4B are diagrams for describing an effect of the present disclosure. FIG. 4A is a diagram illustrating a concept of image segmentation in a case where learning according to the configuration of the present disclosure is not performed.

FIG. 4B is a diagram illustrating a concept of image segmentation after performing learning according to the configuration of the present disclosure.

FIG. 5 is a diagram illustrating an example of a configuration according to a second embodiment of the present disclosure.

FIG. 6 is a diagram illustrating an example of an internal configuration of a geometric parameter estimating layer in the configuration according to the second embodiment of the present disclosure.

FIG. 7 is a flowchart illustrating a detailed example of learning data acquisition processing in the configuration according to the second embodiment of the present disclosure.

FIG. 8 is a flowchart illustrating a detailed example of edge estimation processing in the configuration according to the second embodiment of the present disclosure.

FIG. 9 is a flowchart illustrating a detailed example of cost calculation processing in the configuration according to the second embodiment of the present disclosure.

FIG. 10 is a diagram illustrating an example of a configuration according to a third embodiment of the present disclosure.

FIG. 11 is a flowchart illustrating an example of processing by the configuration according to the third embodiment of the present disclosure.

FIG. 12 is a diagram illustrating a first example of a hardware configuration for implementing the function according to the present disclosure.

FIG. 13 is a diagram illustrating a second example of a hardware configuration for implementing the function according to the present disclosure.

### DESCRIPTION OF EMBODIMENTS

Hereinafter, in order to describe the present disclosure in more detail, embodiments of the present disclosure will be described with reference to the accompanying drawings.

### First Embodiment

A first embodiment describes a form of a learning device.

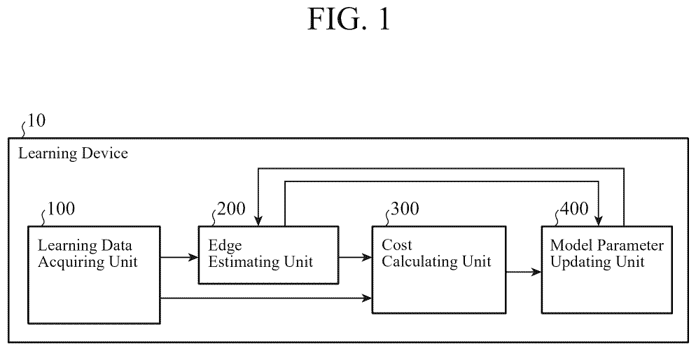

FIG. 1 is a diagram illustrating an example of a configuration according to the first embodiment of the present disclosure.

A learning device 10 updates model parameters of an edge estimating model used for image segmentation by learning processing.

The learning device 10 illustrated in FIG. 1 includes a learning data acquiring unit 100, an edge estimating unit 200, a cost calculating unit 300, and a model parameter updating unit 400.

The learning data acquiring unit 100 acquires learning data used for learning processing by the learning device 10.

The learning data acquiring unit 100 acquires learning data that is a combination of a learning image, a correct edge image, and a correct geometric parameter.

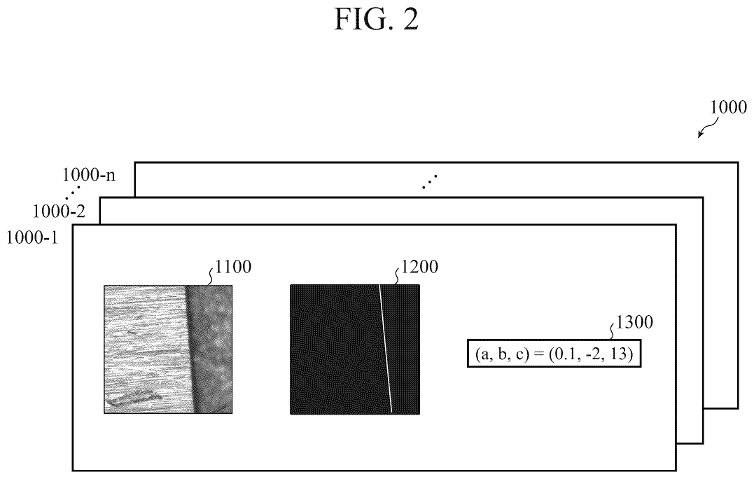

FIG. 2 is a diagram illustrating an example of learning data 1000 (1000-1, 1000-2, . . . , 1000-n) used in the first embodiment of the present disclosure.

As illustrated in FIG. 2, each of the learning data 1000 (1000-1, 1000-2, . . . , 1000-n) is learning data in which a combination of a learning image 1100, a correct edge image 1200, and a correct geometric parameter 1300 is set as one set.

A plurality of sets of the learning data 1000 (1000-1, 1000-2, . . . , 1000-n) is prepared in advance and stored in, for example, a learning database. In a case where the learning database is included in the learning device 10, the learning database is configured by a storage unit (not illustrated) of the learning device 10.

The correct edge image 1200 is an image indicating a correct edge in the learning image 1100, and is, for example, an image in which an edge is indicated by 255 and a non-edge is indicated by 0.

The correct geometric parameter 1300 is a parameter related to a shape of the correct edge, and is, for example, a parameter represented by a coefficient of a mathematical expression representing the shape of the correct edge. The coefficient includes a constant of a constant term.

That is, the learning data acquiring unit 100 acquires the learning data 1000 (1000-1, 1000-2, . . . , 1000-n) which is a combination of the learning image 1100, the correct edge image 1200 indicating the correct edge of the learning image, and the correct geometric parameter 1300 related to the shape of the correct edge.

The correct geometric parameter 1300 is indicated, for example, in the form of vector data in which each coefficient of a mathematical expression representing the shape of the correct edge is used as an element.

In a case where the correct edge has a two-dimensional geometric shape, the correct geometric parameter 1300 is a parameter constituting a mathematical expression (coefficient in the mathematical expression) representing the two-dimensional geometric shape.

In a case where the correct edge has a linear shape, the correct geometric parameter 1300 is a parameter constituting a mathematical expression (coefficient in the mathematical expression) representing a straight line. More specifically, the correct geometric parameter 1300 is indicated in the form of vector data having a vector size “3” in which coefficients (a, b, and c) in a mathematical expression (Expression (1)) representing a straight line are used as elements.

$$ax + by + c = 0 \qquad ( 1 )$$

In a case where the correct edge has an elliptical shape (or circular shape), the correct geometric parameter 1300 is a parameter constituting a mathematical expression (coefficient in the mathematical expression) representing an ellipse (or circle). More specifically, the correct geometric parameter 1300 is indicated in the form of vector data having a vector size “4” in which coefficients (a, b, v, and w) in a mathematical expression (Expression (2)) representing an ellipse (or a circle) are used as elements.

$$\{ {( x - v )}^{2} \} / ( {a}^{2} ) + \{ {( y - w )}^{2} \} / ( {b}^{2} ) = 1 \qquad ( 2 )$$

In a case where the correct edge has a quadratic curve shape, the correct geometric parameter 1300 is a parameter constituting a mathematical expression (coefficient in the mathematical expression) representing a quadratic curve. More specifically, the correct geometric parameter 1300 is indicated in the form of vector data having a vector size “6” in which coefficients (a, b, c, d, e, and f) in a mathematical expression (Expression (3)) representing a quadratic curve are used as elements.

$${ax}^{2} + bxy + {cy}^{2} + dx + ey + f = 0 \qquad ( 3 )$$

As described above, the vector size of the correct geometric parameter 1300 varies depending on the shape of the correct edge. Naturally, the estimated geometric parameter estimated using a learned edge estimating model subjected to learning processing using such a correct edge image and the correct geometric parameter 1300 has a different vector size similarly to the correct geometric parameter 1300.

Note that the curve shape can include not only a quadratic curve but also a curve shape such as a cubic curve, a quaternary curve, . . . , an nth-order curve (n is an integer equal to or more than 2) on the basis of a similar idea. As the correct geometric parameter in this case, coefficients of mathematical expressions representing the cubic curve, the quaternary curve, . . . , the nth-order curve are used as parameters. Naturally, estimated geometric parameters estimated using a learned edge estimating model subjected to learning processing using the correct geometric parameters indicating the coefficients of the mathematical expressions representing the cubic curve, the quaternary curve, . . . , the nth-order curve are parameters indicating the coefficients of the mathematical expressions representing the cubic curve, the quaternary curve, . . . , the nth-order curve, respectively.

The vector size of the vector data indicating the parameters as described above is smaller as the vector data has a simple shape such as a linear shape, and is larger as the vector data has a complicated shape such as an elliptical shape, a quadratic curve, a cubic curve, a quartic curve, . . . , an nth-order curve.

When an image is input, the edge estimating unit 200 estimates an edge in the image and outputs an estimated edge image. Further, the edge estimating unit 200 estimates a geometric parameter related to the shape of the edge indicated in the estimated edge image and outputs the estimated geometric parameter.

The edge estimating unit 200 includes a neural network, and outputs an estimated edge image indicating an estimated edge of the learning image and an estimated geometric parameter related to the shape of the estimated edge by inputting the learning image to the neural network.

The shape of the edge with which estimation accuracy is improved by the edge estimating unit 200 after learning by the learning processing of the present disclosure is a geometric pattern including a two-dimensional geometric shape that can be expressed by a mathematical expression. Examples of the two-dimensional geometric shape include a linear shape, an elliptical shape, a circular shape, and a quadratic curve shape.

The cost calculating unit 300 calculates a cost by comparing an estimation result by the edge estimating unit 200 with correct data indicated in the learning data.

The cost calculating unit 300 calculates a cost for evaluating estimation accuracy by the edge estimating unit 200 using the correct edge image, the correct geometric parameter, the estimated edge image, and the estimated geometric parameter.

For example, the cost calculating unit 300 calculates a cost for evaluating estimation accuracy of an edge image using the estimated edge image and the correct edge image, and calculates a cost for evaluating estimation accuracy of the geometric parameter using the estimated geometric parameter and the correct geometric parameter.

The model parameter updating unit 400 updates model parameters of the neural network constituting the edge estimating unit 200 by using the cost calculated by the cost calculating unit 300.

The model parameter updating unit 400 optimizes the model parameters in such a way as to reduce the cost by using a known method such as an error back propagation method or a stochastic gradient descent (SGD) method.

The model parameter updating unit 400 causes updated model parameters to be stored in such a manner that the edge estimating unit 200 that performs image segmentation processing can use the updated model parameters.

In addition, the learning device 10 may include a control unit (not illustrated) and a storage unit (not illustrated) in addition to the above configuration.

The control unit (not illustrated) controls the entire learning device 10. The control unit (not illustrated) controls, for example, startup and shutdown of the learning device 10. Further, the control unit (not illustrated) determines, for example, the start of learning processing or the start of normal segmentation processing, and issues a command.

The storage unit (not illustrated) stores each piece of data used for the learning device 10. The storage unit (not illustrated) stores, for example, learning data, model parameters, an estimated edge image, and an estimated geometric parameter.

Processing of the learning device 10 will be described.

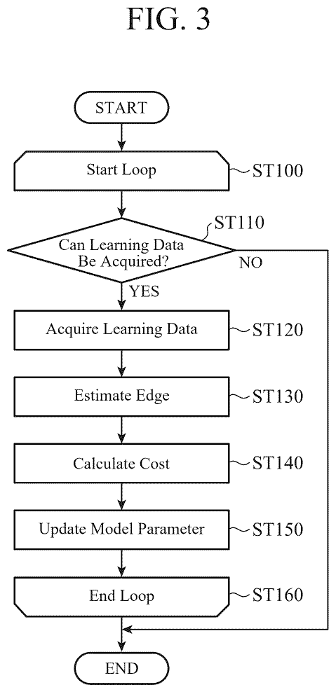

FIG. 3 is a flowchart illustrating an example of processing by the configuration according to the first embodiment of the present disclosure.

Upon starting the learning processing, the learning device 10 starts learning loop processing (step ST100).

Upon starting the learning loop processing, the learning device 10 determines whether learning data can be acquired (step ST110).

When it is determined that the learning data cannot be acquired (step ST110 “NO”), the learning device 10 ends the processing without executing the subsequent learning loop processing.

When it is determined that the learning data can be acquired (step ST110 “YES”), the learning device 10 executes learning data acquisition processing (step ST120).

In the learning data acquisition processing, the learning data acquiring unit 100 of the learning device 10 acquires learning data that is a combination of the learning image, the correct edge image, and the correct geometric parameter.

The learning data acquiring unit 100 acquires, for example, one set of learning data at a time from among learning data stored in the storage unit (not illustrated) in order of random or identification numbers.

The learning device 10 executes edge estimation processing (step ST130).

In the edge estimation processing, when the learning image is input, the edge estimating unit 200 of the learning device 10 first acquires model parameters (model parameters of the edge estimating model) used for the neural network from the storage unit (not illustrated). Next, the edge estimating unit 200 estimates an edge of the input learning image in the learning image via the neural network (deep neural network) according to the model parameters, and outputs an estimated edge image. Further, the edge estimating unit 200 further estimates a geometric parameter related to the shape of the estimated edge indicated in the estimated edge image via the neural network (deep neural network) according to the model parameter, and outputs the estimated geometric parameter.

Note that the initial value of each model parameter may be a randomly determined value.

The learning device 10 executes cost calculation processing (step ST140).

In the cost calculation processing, the cost calculating unit 300 of the learning device 10 calculates a cost by comparing an estimation result by the edge estimating unit 200 with correct data indicated in the learning data.

Specifically, the cost calculating unit 300 calculates a cost for evaluating the estimation accuracy by the edge estimating unit 200 using the correct edge image, the correct geometric parameter, the estimated edge image, and the estimated geometric parameter.

The learning device 10 executes model parameter update processing (step ST150).

In the model parameter update processing, the model parameter updating unit 400 in the learning device 10 updates the model parameter of the neural network in the edge estimating unit 200 by using the cost calculated by the cost calculating unit 300.

The model parameter updating unit 400 causes each of the updated model parameters to be stored in, for example, the storage unit (not illustrated).

After executing the model parameter update processing, the learning device 10 ends one learning loop processing (step ST160) and starts next learning loop processing (step ST100). The learning device 10 can acquire model parameters for edge estimation specialized for edge estimation of the geometric shape by repeating the learning processing of all the sets of the learning data.

Note that, in the description, learning (online learning) using one set of learning data at a time has been described, but a configuration may be employed in which mini-batch learning or batch learning is performed in which a plurality of sets is processed at a time.

Effects of the configuration of the present disclosure will be described.

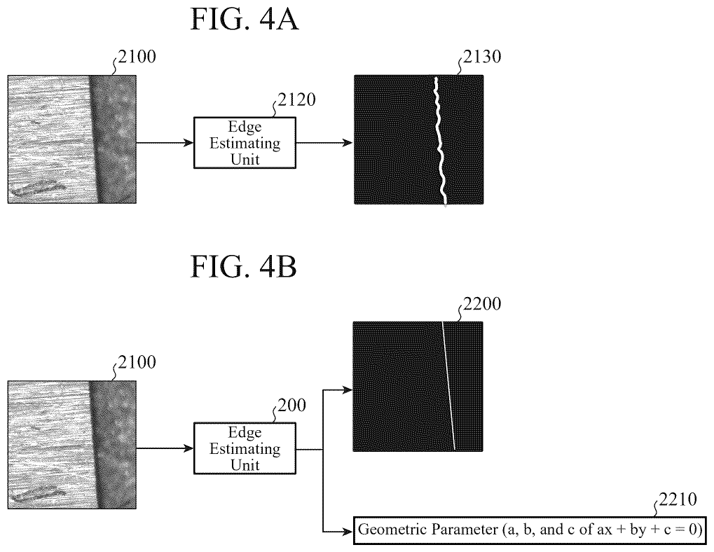

FIG. 4 is a diagram for describing an effect of the present disclosure. FIG. 4A is a diagram illustrating a concept of image segmentation in a case where learning according to the configuration of the present disclosure is not performed. FIG. 4B is a diagram illustrating a concept of image segmentation after performing learning according to the configuration of the present disclosure.

As illustrated in FIG. 4A, an edge estimating unit 2120 that does not perform learning according to the configuration of the present disclosure may output an estimated edge image 2130 in which an edge estimated from an input target processing image 2100 is distorted in a zigzag shape.

On the other hand, as illustrated in FIG. 4B, the edge estimating unit 200 that has performed learning according to the configuration of the present disclosure outputs an estimated edge image 2200 in which an edge estimated from the input target processing image 2100 indicates the original linear shape and a geometric parameter 2210 related to the linear shape of the estimated edge.

As described above, in the present disclosure, with the configuration to estimate the parameter of a geometric pattern as a segmentation target, the estimation model acquires information of the geometric pattern at the time of learning, and thus estimation close to the geometric pattern is performed. As a result, it is possible to improve the segmentation accuracy as compared with a case where there is no estimation of the geometric pattern.

The learning device of the present disclosure is configured as follows.

“A learning device including:
a learning data acquiring unit to acquire learning data that is a combination of a learning image, a correct edge image indicating a correct edge of the learning image, and a correct geometric parameter related to a shape of the correct edge;
an edge estimating unit including a neural network to output an estimated edge image indicating an estimated edge of the learning image and an estimated geometric parameter related to a shape of the estimated edge by inputting the learning image to the neural network;
a cost calculating unit to calculate a cost for evaluating estimation accuracy by the edge estimating unit by using the correct edge image, the correct geometric parameter, the estimated edge image, and the estimated geometric parameter; and
a model parameter updating unit to update a model parameter of the neural network by using the cost calculated by the cost calculating unit.”

Thus, the present disclosure has an effect that a learning device that improves estimation accuracy of image segmentation can be provided.

The learning method of the present disclosure is configured as follows.

“A learning method including:
a learning data acquiring step of causing a learning data acquiring unit to acquire learning data that is a combination of a learning image, a correct edge image indicating a correct edge of the learning image, and a correct geometric parameter related to a shape of the correct edge;
an edge estimating step of causing an edge estimating unit including a neural network to output an estimated edge image indicating an estimated edge of the learning image and an estimated geometric parameter related to a shape of the estimated edge by inputting the learning image to the neural network;
a cost calculating step of causing a cost calculating unit to calculate a cost for evaluating estimation accuracy by the edge estimating unit by using the correct edge image, the correct geometric parameter, the estimated edge image, and the estimated geometric parameter; and
a model parameter updating step of causing a model parameter updating unit to update a model parameter in the neural network by using the cost calculated by the cost calculating unit.”

Thus, the present disclosure has an effect that a learning method that improves estimation accuracy of image segmentation can be provided.

The learning device of the present disclosure is configured as follows.

“The learning device, in which the correct geometric parameter is a coefficient in a mathematical expression representing a two-dimensional geometric shape.”

Thus, the present disclosure has an effect that a learning device that improves estimation accuracy of image segmentation when a segmentation target in an image is a two-dimensional geometric shape can be provided.

Furthermore, the present disclosure achieves an effect similar to the above effect by applying the above configuration to the above learning method.

The learning device of the present disclosure is configured as follows.

“The learning device, in which the correct geometric parameter is a coefficient in a mathematical expression representing a straight line.”

Thus, the present disclosure has an effect that a learning device that improves estimation accuracy of image segmentation when a segmentation target in an image is a linear shape can be provided.

Furthermore, the present disclosure achieves an effect similar to the above effect by applying the above configuration to the above learning method.

The learning device of the present disclosure is configured as follows.

“The learning device, in which the correct geometric parameter is a coefficient in a mathematical expression representing a circle.”

Thus, the present disclosure has an effect that a learning device that improves estimation accuracy of image segmentation when a segmentation target in an image is circular can be provided.

Furthermore, the present disclosure achieves an effect similar to the above effect by applying the above configuration to the above learning method.

The learning device of the present disclosure is configured as follows.

“The learning device, in which the correct geometric parameter is a coefficient in a mathematical expression representing an ellipse.”

Thus, the present disclosure has an effect that a learning device that improves estimation accuracy of image segmentation when a segmentation target in an image is an elliptical shape can be provided.

Furthermore, the present disclosure achieves an effect similar to the above effect by applying the above configuration to the above learning method.

The learning device of the present disclosure is configured as follows.

“The learning device, in which the correct geometric parameter is a coefficient in a mathematical expression representing an n-th order curve (n≥2).”

Thus, the present disclosure has an effect that a learning device that improves estimation accuracy of image segmentation when a segmentation target in an image is an nth-order curve shape (n≥2) such as a quadratic curve shape, a cubic curve shape, a quartic curve shape, . . . can be provided.

Furthermore, the present disclosure achieves an effect similar to the above effect by applying the above configuration to the above learning method.

### Second Embodiment

In a second embodiment, an example of a detailed configuration of a learning device will be described.

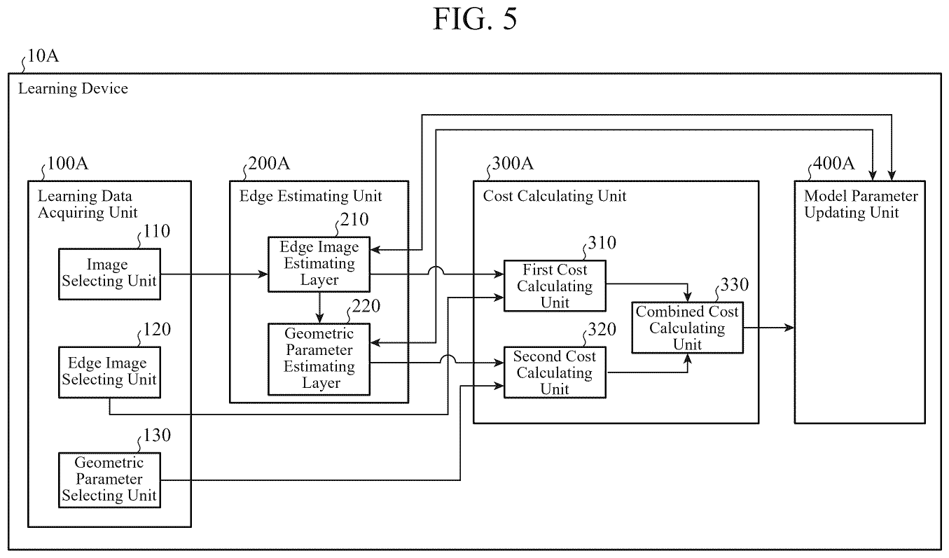

FIG. 5 is a diagram illustrating an example of a configuration according to the second embodiment of the present disclosure.

A learning device 10A illustrated in FIG. 5 includes a learning data acquiring unit 100A, an edge estimating unit 200A, a cost calculating unit 300A, and a model parameter updating unit 400A.

The learning data acquiring unit 100A acquires learning data.

The learning data acquiring unit 100A acquires learning data that is a combination of a learning image, a correct edge image, and a correct geometric parameter.

Specifically, the learning data acquiring unit 100A acquires learning data that is a combination of a learning image, a correct edge image indicating a correct edge of the learning image, and a correct geometric parameter related to a shape of the correct edge.

Since specific examples of the learning image, the correct edge image, and the correct geometric parameter have already been described with reference to FIG. 2, further description thereof will be omitted here.

The learning data acquiring unit 100A includes an image selecting unit 110, an edge image selecting unit 120, and a geometric parameter selecting unit 130.

The image selecting unit 110 selects and acquires a learning image.

Specifically, the image selecting unit 110 sequentially selects a learning image for each set from among a plurality of pieces of learning data.

The edge image selecting unit 120 selects and acquires a correct edge image.

Specifically, the edge image selecting unit 120 sequentially selects a correct edge image combined with the learning image for each set from among the plurality of pieces of learning data.

The geometric parameter selecting unit 130 selects and acquires a correct geometric parameter.

Specifically, the geometric parameter selecting unit 130 sequentially selects a correct geometric parameter combined with the learning image and the correct edge image for each set from among the plurality of pieces of learning data.

When an image is input, the edge estimating unit 200A estimates an edge in the image and outputs an estimated edge image. Further, the edge estimating unit 200A estimates a geometric parameter related to the shape of the edge indicated in the estimated edge image, and outputs the estimated geometric parameter.

As described above, the shape of the edge whose estimation accuracy is improved by the edge estimating unit 200A after learning by the learning processing of the present disclosure is a geometric pattern including a two-dimensional geometric shape that can be expressed by a mathematical expression. Examples of the two-dimensional geometric shape include a linear shape, an elliptical shape, a circular shape, and a quadratic curve shape.

The edge estimating unit 200A includes a neural network, and outputs an estimated edge image when a target image for image segmentation processing is input to the neural network.

In a case where the learning device 10A executes learning processing, the edge estimating unit 200A including a neural network outputs an estimated edge image indicating an estimated edge of the learning image and an estimated geometric parameter related to a shape of the estimated edge by inputting the learning image to the neural network.

Specifically, the edge estimating unit 200A uses a deep neural network (DNN) according to model parameters after learning by the learning processing as a neural network.

An example of a specific configuration of the edge estimating unit 200A will be described.

The edge estimating unit 200A includes an edge image estimating layer 210 and a geometric parameter estimating layer 220.

The edge image estimating layer 210 includes a neural network, and outputs an estimated edge image indicating an estimated edge of the learning image by inputting the learning image to the neural network.

Specifically, it is sufficient if the edge image estimating layer 210 is configured to be able to estimate an edge image from an input image and output the estimated edge image, and is specifically, for example, a deep neural network using a general method such as DexiNed, RCF, BDCN, or CATS.

The estimated edge image that is the estimation result of the edge image estimating layer 210 is an image having the same resolution with the same width and height as the input image (target image or learning image), and is an image having an edge probability (value of 0 to 1) at each pixel value. Here, without being limited thereto, an image having a size different from the size of the input image or a configuration in which meaning of pixel values is different may be used.

The geometric parameter estimating layer 220 includes a neural network, and outputs an estimated geometric parameter related to the shape of the estimated edge indicated in the estimated edge image by inputting the estimated edge image to the neural network.

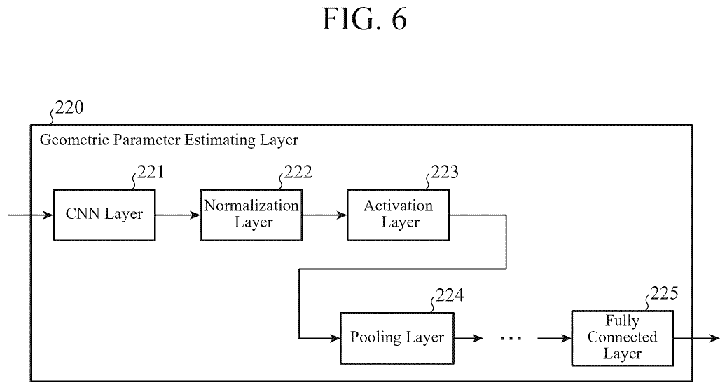

FIG. 6 is a diagram illustrating an example of an internal configuration of the geometric parameter estimating layer 220 in the configuration according to the second embodiment of the present disclosure.

The geometric parameter estimating layer 220 utilizes a deep neural network.

As illustrated in FIG. 6, the geometric parameter estimating layer 220 includes, for example, a convolutional neural network (CNN) layer 221, a normalization layer 222, an activation layer 223, a pooling layer 224, and a fully connected layer 225.

The geometric parameter estimating layer 220 includes a free combination of the CNN layer 221, the normalization layer 222, the activation layer 223, the pooling layer 224, and the fully connected layer 225.

Specifically, the geometric parameter estimating layer 220 outputs, for example, a vector having an estimated geometric parameter as an element.

The cost calculating unit 300A calculates a cost by comparing an estimation result by the edge estimating unit 200A with correct data indicated in the learning data.

The cost calculating unit 300A calculates a cost for evaluating the estimation accuracy by the edge estimating unit 200A using the correct edge image, the correct geometric parameter, the estimated edge image, and the estimated geometric parameter.

The cost calculated by the cost calculating unit 300A is a cost used in the learning processing of the learning device 10A.

The cost calculated by the cost calculating unit 300A is, for example, a cost L_e(I) and a cost L_g(P) expressed by a cost function L(I, P) of the following Expression (4).

$$L ( I , P ) = L\_e ( I ) + λ\_gL \_g ( P ) = {\vert P - {P}^{1} \vert}^{2} \qquad ( 4 )$$

The cost L_e(I) is a cost (hereinafter, also referred to as a “first cost”) for evaluating the estimation accuracy of the estimated edge image I. The first cost L_e(I) is a cost for learning the edge image estimating layer 210. The first cost L_e(I) is not limited to a specific method as long as the estimation accuracy of the estimated edge image I can be evaluated from the difference between a correct edge image I¹ and the estimated edge image I.

The cost L_g(P) is a cost (hereinafter, also referred to as a “second cost”) for evaluating estimation accuracy of the estimated geometric parameter. The second cost L_g(P) is a cost for learning the geometric parameter estimating layer 220. In Expression (4), the cost L_g(P) is defined as the sum of squares of a difference between a correct geometric parameter P^{l} and the estimated geometric parameter P.

A weight λ_g is a weight for adjusting the balance (performing balancing) between the first cost L_e(I) and the second cost L_g(P).

An example of a specific configuration of the cost calculating unit 300A will be described.

The cost calculating unit 300A includes a first cost calculating unit 310, a second cost calculating unit 320, and a combined cost calculating unit 330.

The first cost calculating unit 310 calculates the first cost L_e(I) for evaluating estimation accuracy of the edge image estimating layer 210 using the correct edge image and the estimated edge image.

The second cost calculating unit 320 calculates the second cost L_g(P) (=|P−P¹|²) for evaluating estimation accuracy of the geometric parameter estimating layer 220 using the correct geometric parameter and the estimated geometric parameter.

The combined cost calculating unit 330 calculates a cost obtained by combining the first cost L_e(I) and the second cost L_g(P).

The combined cost calculating unit 330 calculates a sum of a value of the first cost L_e(I) and a value obtained by multiplying a value of the second cost L_g(P) by the weight λ_g as a combined cost L(I, P).

The model parameter updating unit 400A updates and outputs the model parameter of the neural network in the edge estimating unit 200A using the cost (see Expression (4)) calculated by the cost calculating unit 300A.

In a case where the learning device 10A is included in a part of the image segmentation device, the model parameter updating unit 400A may be configured to directly update the model parameter of the neural network in the edge estimating unit 200A by using the cost calculated by the cost calculating unit 300A.

The model parameter updating unit 400A optimizes and updates the model parameter in the neural network in such a way as to reduce the cost calculated by the cost calculating unit 300A.

Specifically, the model parameter updating unit 400A calculates the model parameter in such a way as to reduce the cost (see Expression (4)) using a known method such as an error back propagation method or a stochastic gradient descent (SGD) method, and optimizes and updates the model parameter in the neural network.

The model parameter updating unit 400A causes the optimized model parameters to be stored in, for example, a storage unit (not illustrated) to be described later.

Note that, in a case where the learning device 10A and the image segmentation device are configured as separate devices, the model parameter updating unit 400B may store the updated model parameter in the storage unit (not illustrated) in the image segmentation device. In this case, by the learning device, by inputting a learning image to the neural network of the edge estimating unit by using the learning data that is a combination of the learning image, the correct edge image indicating a correct edge of the learning image, and the correct geometric parameter related to the shape of the correct edge, an estimated edge image indicating an estimated edge of the learning image and an estimated geometric parameter related to the shape of the estimated edge are output, the cost for evaluating the estimation accuracy by the edge estimating unit is calculated by using the correct edge image, the correct geometric parameter, the estimated edge image, and the estimated geometric parameter, and the model parameter of the neural network in the edge estimating unit of the image segmentation device is updated by using the calculated cost.

The learning device 10A may include a control unit (not illustrated) and a storage unit (not illustrated) in addition to the above configuration.

The control unit (not illustrated) controls the entire learning device 10A. The control unit (not illustrated) controls, for example, startup and shutdown of the learning device 10A. Further, the control unit (not illustrated) determines, for example, the start of learning processing or the start of normal segmentation processing, and issues a command.

The storage unit (not illustrated) stores each piece of data used for the learning device 10A. The storage unit (not illustrated) stores, for example, learning data, model parameters, an estimated edge image, and an estimated geometric parameter.

Since the processing of the learning device 10A according to the second embodiment overlaps with the description of the processing illustrated in FIG. 3 already described, the overlapping description will be omitted.

Here, a detailed example of learning data acquisition processing, a detailed example of edge estimation processing, and a detailed example of cost calculation processing will be described.

First, a detailed example of the learning data acquisition processing will be described.

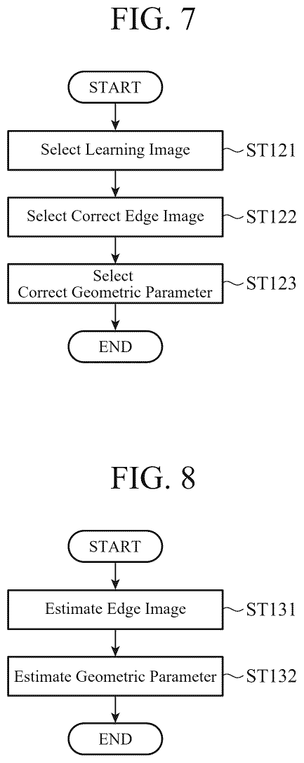

FIG. 7 is a flowchart illustrating a detailed example of the learning data acquisition processing in the configuration according to the second embodiment of the present disclosure.

Upon starting the learning data acquisition processing, the learning data acquiring unit 100A first executes learning image selection processing (step ST121).

In the learning image selection processing, the image selecting unit 110 of the learning data acquiring unit 100A refers to the storage unit (not illustrated) and sequentially selects a learning image for each set from among a plurality of pieces of learning data.

Next, the learning data acquiring unit 100A executes correct edge image selection processing (step ST122).

In the correct edge image selection processing, the edge image selecting unit 120 of the learning data acquiring unit 100A refers to the storage unit (not illustrated), and sequentially selects a correct edge image combined with the learning image for each set from among the plurality of pieces of learning data.

Next, the learning data acquiring unit 100A executes correct geometric parameter selection processing (step ST123).

In the correct geometric parameter selection processing, the geometric parameter selecting unit 130 of the learning data acquiring unit 100A refers to the storage unit (not illustrated), and sequentially selects a correct geometric parameter combined with the learning image and the correct edge image for each set from among the plurality of pieces of learning data.

The learning data acquiring unit 100A outputs the learning image to the edge estimating unit 200A, outputs the correct edge image and the correct geometric parameter to the cost calculating unit 300A, and ends the learning data acquisition processing for one set of learning data.

Next, a detailed example of the edge estimation processing will be described.

FIG. 8 is a flowchart illustrating a detailed example of the edge estimation processing in the configuration according to the second embodiment of the present disclosure.

Upon starting the edge estimation processing, the edge estimating unit 200A first executes edge image estimation processing (step ST131).

In the edge image estimation processing, the edge image estimating layer 210 of the edge estimating unit 200A outputs an estimated edge image indicating an estimated edge of the learning image by inputting the learning image to the neural network constituting the edge image estimating layer 210.

Next, the edge estimating unit 200A executes geometric parameter estimation processing (step ST132).

In the geometric parameter estimation processing, the geometric parameter estimating layer 220 of the edge estimating unit 200A outputs the estimated geometric parameter related to the shape of the estimated edge indicated in the estimated edge image by inputting the estimated edge image to the neural network constituting the geometric parameter estimating layer 220.

After outputting the estimated edge image and the estimated geometric parameter to the cost calculating unit 300A, the edge estimating unit 200A ends the edge estimation processing.

Next, a detailed example of the cost calculation processing will be described.

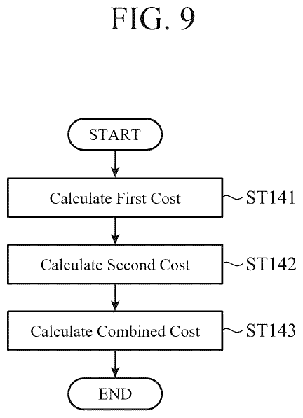

FIG. 9 is a flowchart illustrating a detailed example of the cost calculation processing in the configuration according to the second embodiment of the present disclosure.

Upon starting the cost calculation processing, the cost calculating unit 300A first executes first cost calculation processing (step ST141).

In the first cost calculation processing, the first cost calculating unit 310 in the cost calculating unit 300A calculates the first cost L_e(I) for evaluating estimation accuracy of the edge image estimating layer 210 using the correct edge image and the estimated edge image.

Next, the cost calculating unit 300A executes second cost calculation processing (step ST142).

In the second cost calculation processing, the second cost calculating unit 320 in the cost calculating unit 300A calculates the second cost L_g(P) (=|P−P¹|²) for evaluating the estimation accuracy of the geometric parameter estimating layer 220 using the correct geometric parameter and the estimated geometric parameter.

Next, the cost calculating unit 300A executes combined cost calculation processing (step ST143).

In the combined cost calculation processing, the combined cost calculating unit 330 of the cost calculating unit 300A calculates a cost obtained by combining the first cost L_e(I) and the second cost L_g(P). Specifically, the combined cost calculating unit 330 calculates the sum of the value of the first cost L_e(I) and the value obtained by multiplying the value of the second cost L_g(P) by the weight λ_g as the combined cost L(I, P).

After outputting the combined cost L(I, P) including the first cost L_e(I), the second cost L_g(P), and the weight λ_g to the model parameter updating unit 400A, the cost calculating unit 300A ends the cost calculation processing.

The edge estimating unit 200A after learning in which learning by the configuration of the present disclosure is performed outputs an estimated edge image 2200 in which an edge estimated from an input target processing image 2100 indicates the original shape (geometrical shape such as a linear shape, an elliptical shape, a circular shape, or a quadratic curve shape) and a geometric parameter 2210 related to the shape of the estimated edge, similarly to the description already given with reference to FIG. 4B.

The learning device of the present disclosure is configured as follows.

“The learning device according, in which
the edge estimating unit includes:
an edge image estimating layer including a neural network to output an estimated edge image indicating an estimated edge of the learning image by inputting the learning image to the neural network; and
a geometric parameter estimating layer including a neural network to output an estimated geometric parameter related to a shape of the estimated edge indicated in the estimated edge image by inputting the estimated edge image to the neural network.”

Thus, the present disclosure has an effect that it is possible to provide a learning device that improves estimation accuracy of image segmentation by a configuration in which the geometric parameter estimating layer that newly outputs an estimated geometric parameter is added to the edge image estimating layer that outputs an estimated edge image.

Furthermore, the present disclosure achieves an effect similar to the above effect by applying the above configuration to the above learning method.

The learning device of the present disclosure is configured as follows.

“The learning device, in which
the cost calculating unit includes:
a first cost calculating unit to calculate a first cost for evaluating estimation accuracy of the edge image estimating layer using the correct edge image and the estimated edge image;
a second cost calculating unit to calculate a second cost for evaluating estimation accuracy of the geometric parameter estimating layer using the correct geometric parameter and the estimated geometric parameter; and
a combined cost calculating unit to calculate a cost obtained by combining the first cost and the second cost.”

Thus, the present disclosure has an effect that it is possible to provide a learning device that improves the estimation accuracy of image segmentation by updating the model parameter of the neural network in consideration of the evaluation of the estimation accuracy of the edge image estimating layer and the evaluation of the estimation accuracy of the geometric parameter estimating layer.

Furthermore, the present disclosure achieves an effect similar to the above effect by applying the above configuration to the above learning method.

### Third Embodiment

A third embodiment will describe a mode applied to an image segmentation device.

An image segmentation device according to the third embodiment is an image segmentation device that has model parameters optimized by learning processing by the learning device 10 of the first embodiment or the learning device 10A of the second embodiment and executes image segmentation using the model parameters, or an image segmentation device including the learning device 10 of the first embodiment or the learning device 10A of the second embodiment.

That is, the image segmentation device according to the third embodiment executes image segmentation using an edge estimating model optimized by the learning device 10 of the first embodiment or the learning device 10A of the second embodiment.

In this case, by the learning device, by inputting a learning image to the neural network of the edge estimating unit by using the learning data that is a combination of the learning image, the correct edge image indicating a correct edge of the learning image, and the correct geometric parameter related to the shape of the correct edge, an estimated edge image indicating an estimated edge of the learning image and an estimated geometric parameter related to the shape of the estimated edge are output, the cost for evaluating the estimation accuracy by the edge estimating unit is calculated by using the correct edge image, the correct geometric parameter, the estimated edge image, and the estimated geometric parameter, and the model parameter of the neural network in the edge estimating unit of the image segmentation device is updated by using the calculated cost.

The image segmentation device according to the third embodiment will be described using an image segmentation device including the learning device 10A of the second embodiment.

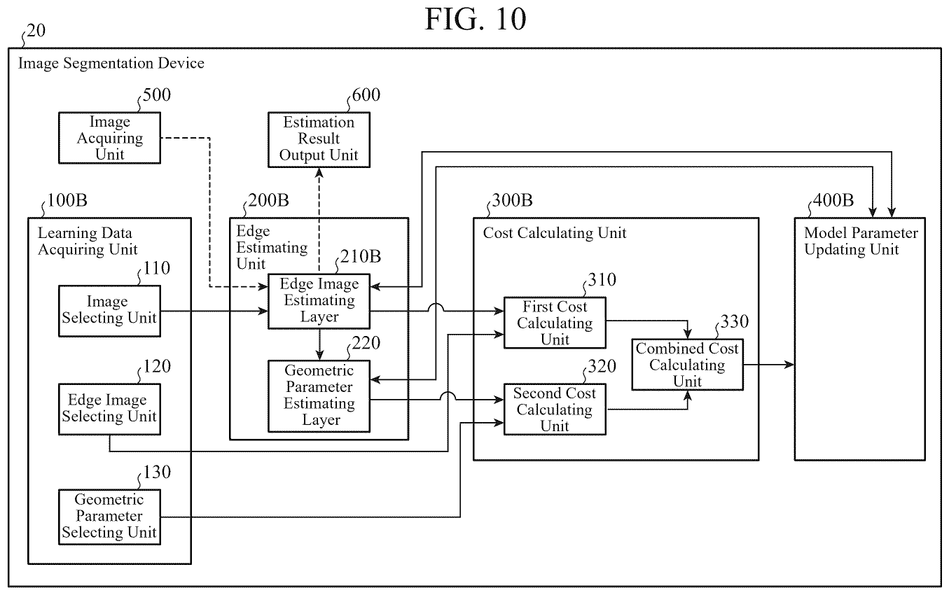

FIG. 10 is a diagram illustrating an example of a configuration according to a third embodiment of the present disclosure.

An image segmentation device 20 illustrated in FIG. 10 includes a learning data acquiring unit 100B, an edge estimating unit 200B, a cost calculating unit 300B, a model parameter updating unit 400B, an image acquiring unit 500, and an estimation result output unit 600.

The learning data acquiring unit 100B acquires learning data similarly to the learning data acquiring unit 100A described above.

The learning data acquiring unit 100B acquires learning data that is a combination of a learning image, a correct edge image, and a correct geometric parameter.

Similarly to the learning data already described with reference to FIG. 2, the learning data is learning data in which a combination of the learning image, the correct edge image, and the correct geometric parameter is set as one set.

A plurality of sets of learning data is prepared in advance and stored in, for example, a learning database. In a case where the learning database is included in the image segmentation device 20, the learning database is configured by a storage unit (not illustrated) of the image segmentation device 20.

The correct edge image is an image indicating a correct edge in the learning image, and is, for example, an image in which an edge is indicated by 255 and a non-edge is indicated by 0.

The correct geometric parameter is a parameter related to a shape of the correct edge, and is, for example, a parameter represented by a coefficient of a mathematical expression representing the shape of the correct edge. The coefficient includes a constant of a constant term.

That is, the learning data acquiring unit 100B acquires the learning data that is a combination of the learning image, the correct edge image indicating the correct edge of the learning image, and the correct geometric parameter related to the shape of the correct edge.

The correct geometric parameter 1300 is indicated, for example, in the form of vector data in which coefficients of a mathematical expression representing the shape of the correct edge are used as elements.

In a case where the correct edge has a two-dimensional geometric shape, the correct geometric parameter 1300 is a parameter constituting a mathematical expression (coefficient in the mathematical expression) representing the two-dimensional geometric shape.

In a case where the correct edge has a linear shape, the correct geometric parameter 1300 is a parameter constituting a mathematical expression (coefficient in the mathematical expression) representing a straight line. More specifically, the correct geometric parameter 1300 is indicated in the form of vector data having a vector size “3” in which coefficients (a, b, and c) in a mathematical expression representing a straight line (already described Expression (1)) are used as elements.

In a case where the correct edge has an elliptical shape (or circular shape), the correct geometric parameter 1300 is a parameter constituting a mathematical expression (coefficient in the mathematical expression) representing an ellipse (or circle). More specifically, the correct geometric parameter 1300 is indicated in the form of vector data having a vector size “4” in which coefficients (a, b, v, and w) in a mathematical expression representing an ellipse (or a circle) (already described Expression (2)) are used as elements.

In a case where the correct edge has a quadratic curve shape, the correct geometric parameter 1300 is a parameter constituting a mathematical expression (coefficient in the mathematical expression) representing a quadratic curve. More specifically, the correct geometric parameter 1300 is indicated in the form of vector data having a vector size “6” in which coefficients (a, b, c, d, e, and f) in a mathematical expression representing a quadratic curve (already described Expression (3)) are used as elements.

As described above, the vector size of the correct geometric parameter varies depending on the shape of the correct edge. Naturally, the estimated geometric parameter estimated using a learned edge estimating model subjected to learning processing using such a correct edge image and the correct geometric parameter has a different vector size similarly to the correct geometric parameter.

The learning data acquiring unit 100B includes an image selecting unit 110, an edge image selecting unit 120, and a geometric parameter selecting unit 130, similarly to the learning data acquiring unit 100A described above.

The image selecting unit 110 selects and acquires a learning image.

Specifically, the image selecting unit 110 sequentially selects a learning image for each set from among a plurality of pieces of learning data.

The edge image selecting unit 120 selects and acquires a correct edge image.

Specifically, the edge image selecting unit 120 sequentially selects a correct edge image combined with the learning image for each set from among the plurality of pieces of learning data.

The geometric parameter selecting unit 130 selects and acquires a correct geometric parameter.

Specifically, the geometric parameter selecting unit 130 sequentially selects a correct geometric parameter combined with the learning image and the correct edge image for each set from among the plurality of pieces of learning data.

When an image is input, the edge estimating unit 200B estimates an edge in the image and outputs an estimated edge image. Further, the edge estimating unit 200B estimates a geometric parameter related to the shape of the edge indicated in the estimated edge image and outputs the estimated geometric parameter.

The shape of the edge is a geometric pattern including a two-dimensional geometric shape that can be expressed by a mathematical expression.

The edge estimating unit 200B includes a neural network, and outputs an estimated edge image when the target image is input to the neural network.

In a case where the image segmentation device 20 executes the learning processing, the edge estimating unit 200B outputs the estimated edge image indicating an estimated edge of the learning image and the estimated geometric parameter related to a shape of the estimated edge by inputting the learning image to the neural network.

Specifically, the edge estimating unit 200B uses a deep neural network (DNN) according to model parameters after learning by the learning processing of the image segmenting device 20 as a neural network.

An example of a specific configuration of the edge estimating unit 200B will be described.

The edge estimating unit 200B includes an edge image estimating layer 210B and a geometric parameter estimating layer 220.

The edge image estimating layer 210B includes a neural network, and outputs an estimated edge image indicating an estimated edge of the learning image by inputting the learning image to the neural network.

Specifically, it is sufficient if the edge image estimating layer 210B is configured to be able to estimate an edge image from an input image and output the estimated edge image, and is specifically, for example, a deep neural network using a general method such as DexiNed, RCF, BDCN, or CATS.

The estimated edge image that is an estimation result of the edge image estimating layer 210B is an image having the same resolution with the same width and height as the input image (target image or learning image), and is an image having an edge probability (value of 0 to 1) at each pixel value. Here, without being limited thereto, an image having a size different from the size of the input image or a configuration in which meaning of pixel values is different may be used.

The geometric parameter estimating layer 220 includes a neural network, and outputs the estimated geometric parameter related to the shape of the estimated edge indicated in the estimated edge image by inputting the estimated edge image to the neural network.

Similarly to the geometric parameter estimating layer 220 described above, the geometric parameter estimating layer 220 includes, for example, a CNN layer 221, a normalization layer 222, an activation layer 223, a pooling layer 224, and a fully connected layer 225.

The geometric parameter estimating layer 220 includes a free combination of the CNN layer 221, the normalization layer 222, the activation layer 223, the pooling layer 224, and the fully connected layer 225.

Specifically, the geometric parameter estimating layer 220 outputs, for example, a vector having an estimated geometric parameter as an element.

The cost calculating unit 300B calculates a cost by comparing an estimation result by the edge estimating unit 200B with correct data indicated in the learning data.

The cost calculating unit 300B calculates a cost for evaluating the estimation accuracy by the edge estimating unit 200B using the correct edge image, the correct geometric parameter, the estimated edge image, and the estimated geometric parameter.

The cost calculated by the cost calculating unit 300B is a cost used in the learning processing of the image segmentation device 20.

The cost calculated by the cost calculating unit 300B is, for example, the cost L_e(I) and the cost L_g(P) expressed by the cost function L(I, P) of Expression (4) described above.

Since Expression (4), the first cost L_e(I), the second cost L_g(P), and the weight λ_g overlap with the contents already described, the description thereof is omitted here.

An example of a specific configuration of the cost calculating unit 300B will be described.

The cost calculating unit 300B includes a first cost calculating unit 310, a second cost calculating unit 320, and a combined cost calculating unit 330, similarly to the cost calculating unit 300A described above.

The first cost calculating unit 310 calculates the first cost L_e(I) for evaluating estimation accuracy of the edge image estimating layer 210 using the correct edge image and the estimated edge image.

The second cost calculating unit 320 calculates the second cost L_g(P) (=|P−P¹|²) for evaluating estimation accuracy of the geometric parameter estimating layer 220 using the correct geometric parameter and the estimated geometric parameter.

The combined cost calculating unit 330 calculates a cost obtained by combining the first cost L_e(I) and the second cost L_g(P).

The combined cost calculating unit 330 calculates a sum of a value of the first cost L_e(I) and a value obtained by multiplying a value of the second cost L_g(P) by the weight λ_g as a combined cost L(I, P).

The model parameter updating unit 400B updates and outputs the model parameter of the neural network in the edge estimating unit 200B using the cost (see Expression (4)) calculated by the cost calculating unit 300B.

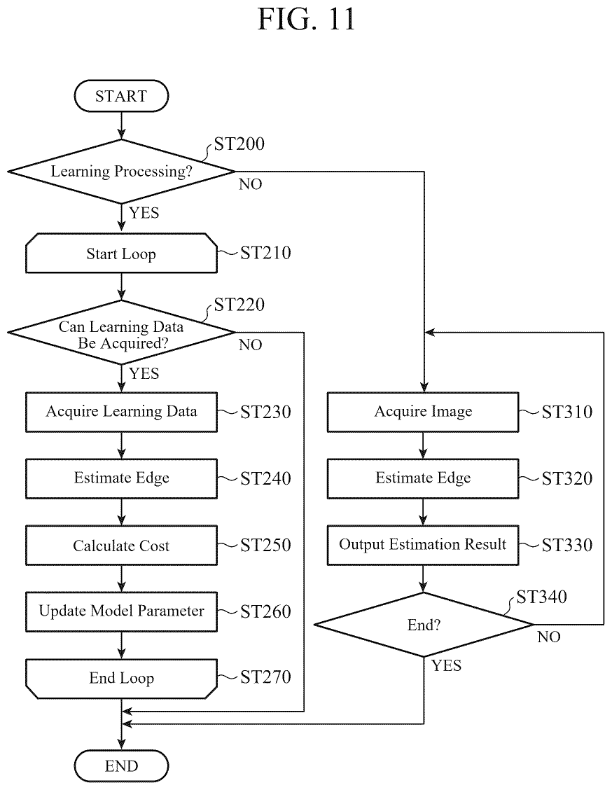

In a case where the image segmentation device 20 includes the learning devices 10 and 10A (in a case of being configured as illustrated in FIG. 11), the model parameter updating unit 400B updates the model parameter in the neural network of the edge estimating unit 200B by using the cost calculated by the cost calculating unit 300B.

The model parameter updating unit 400B optimizes and outputs a model parameter in the neural network in such a way as to reduce the cost (see Expression (4)) calculated by the cost calculating unit 300B.

Specifically, the model parameter updating unit 400B calculates the model parameter in such a way as to reduce the cost (see Expression (4)) using a known method such as an error back propagation method or a stochastic gradient descent (SGD) method, and optimizes the model parameter in the neural network.

The model parameter updating unit 400B causes the optimized model parameters to be stored in, for example, the storage unit (not illustrated) to be described later.

When the image segmentation device 20 executes normal segmentation processing instead of learning processing, the image acquiring unit 500 acquires a target image that is a processing target of the normal segmentation processing.

When the image segmentation device 20 executes normal segmentation processing instead of learning processing, the estimation result output unit 600 outputs the estimated edge image output by the edge estimating unit 200B.

The image segmentation device 20 may include a control unit (not illustrated) and a storage unit (not illustrated) in addition to the above configuration.

The control unit (not illustrated) controls the entire image segmentation device 20. The control unit (not illustrated) controls, for example, startup and shutdown of the image segmentation device 20. Further, the control unit (not illustrated) determines, for example, the start of learning processing or the start of normal segmentation processing, and issues a command.

The storage unit (not illustrated) stores each piece of data used for the image segmentation device 20. The storage unit (not illustrated) stores, for example, learning data, model parameters, an estimated edge image, and an estimated geometric parameter.

Processing of the image segmentation device 20 according to the third embodiment will be described.

FIG. 11 is a flowchart illustrating an example of processing by the configuration according to the third embodiment of the present disclosure.

The image segmentation device 20 is activated, for example, in response to a command from the outside.

The image segmentation device 20 determines whether to execute learning processing (step ST200).

Specifically, for example, upon receiving an instruction to execute the learning processing from the outside, the image segmentation device 20 determines that the control unit (not illustrated) executes the learning processing (step ST200 “YES”).

Further, in a case where the image segmentation device 20 does not receive a command to execute the learning processing or in a case where the image acquiring unit 500 has acquired the target image, it is determined not to execute the learning processing (step ST200 “NO”).

When it is determined to execute the learning processing (step ST200 “YES”), the image segmentation device 20 proceeds to the learning processing (learning loop processing from step ST210 to step ST 270).

Upon starting the learning loop processing, the image segmentation device 20 determines whether learning data can be acquired (step ST220). The image segmentation device 20 refers to, for example, the storage unit (not illustrated) to confirm the presence or absence of the learning data and the number of sets.

When it is determined that the learning data cannot be acquired (step ST220 “NO”), the image segmentation device 20 ends the processing without executing the subsequent learning loop processing.

When it is determined that the learning data can be acquired (step ST220 “YES”), the image segmentation device 20 executes learning data acquisition processing (step ST230).

In the learning data acquisition processing, the learning data acquiring unit 100B of the image segmentation device 20 acquires learning data that is a combination of the learning image, the correct edge image, and the correct geometric parameter.

The learning data acquiring unit 100B acquires, for example, one set of learning data at a time from among learning data stored in the storage unit (not illustrated) in order of random or identification numbers.

A detailed example of the learning data acquisition processing will be described with reference to FIG. 7.

Upon starting the learning data acquisition processing, the learning data acquiring unit 100B first executes learning image selection processing (step ST121).

In the learning image selection processing, the image selecting unit 110 of the learning data acquiring unit 100B refers to the storage unit (not illustrated) and sequentially selects a learning image for each set from among the plurality of pieces of learning data.

Next, the learning data acquiring unit 100B executes correct edge image selection processing (step ST122).

In the correct edge image selection processing, the edge image selecting unit 120 of the learning data acquiring unit 100B refers to the storage unit (not illustrated), and sequentially selects a correct edge image combined with the learning image selected by the image selecting unit 110 for each set from among the plurality of pieces of learning data.

Next, the learning data acquiring unit 100B executes correct geometric parameter selection processing (step ST123).

In the correct geometric parameter selection processing, the geometric parameter selecting unit 130 of the learning data acquiring unit 100B refers to the storage unit (not illustrated), and sequentially selects a correct geometric parameter combined with the learning image selected by the image selecting unit 110 and the correct edge image selected by the edge image selecting unit 120 for each set from among the plurality of pieces of learning data.

The learning data acquiring unit 100B outputs the learning image to the edge estimating unit 200B, outputs the correct edge image and the correct geometric parameter to the cost calculating unit 300B, and ends the learning data acquisition processing for one set of learning data.

The description returns to the processing illustrated in FIG. 11.

The image segmentation device 20 executes edge estimation processing (step ST240).

In the edge estimation processing, when the learning image is input, the edge estimating unit 200B of the image segmentation device 20 first acquires model parameters (model parameters of the edge estimating model) used for the neural network from the storage unit (not illustrated). Next, the edge estimating unit 200B estimates an edge of the input learning image in the learning image via a neural network (deep neural network) according to model parameters, and outputs an estimated edge image. Further, the edge estimating unit 200B further estimates a geometric parameter related to the shape of the estimated edge indicated in the estimated edge image via the neural network (deep neural network) according to the model parameter, and outputs the estimated geometric parameter.

Note that the initial value of each model parameter may be a randomly determined value.

A detailed example of the edge estimation processing will be described with reference to FIG. 8.

Upon starting the edge estimation processing, the edge estimating unit 200B first executes edge image estimation processing (step ST131).

In the edge image estimation processing, the edge image estimating layer 210B of the edge estimating unit 200B outputs an estimated edge image indicating an estimated edge of the learning image by inputting the learning image to the neural network constituting the edge image estimating layer 210B.

Next, the edge estimating unit 200B executes geometric parameter estimation processing (step ST132).

In the geometric parameter estimation processing, the geometric parameter estimating layer 220 of the edge estimating unit 200B outputs the estimated geometric parameter related to the shape of the estimated edge indicated in the estimated edge image by inputting the estimated edge image to the neural network constituting the geometric parameter estimating layer 220.

After outputting the estimated edge image and the estimated geometric parameter to the cost calculating unit 300B, the edge estimating unit 200B ends the edge estimation processing.

The description returns to the processing illustrated in FIG. 11.

The image segmentation device 20 executes cost calculation processing (step ST250).

In the cost calculation processing, the cost calculating unit 300B of the image segmentation device 20 calculates a cost by comparing an estimation result by the edge estimating unit 200B with correct data indicated in the learning data.

Specifically, the cost calculating unit 300B calculates a cost for evaluating the estimation accuracy by the edge estimating unit 200B using the correct edge image, the correct geometric parameter, the estimated edge image, and the estimated geometric parameter.

A detailed example of the cost calculation processing will be described with reference to FIG. 9.

Upon starting the cost calculation processing, the cost calculating unit 300B first executes first cost calculation processing (step ST141).

In the first cost calculation processing, the first cost calculating unit 310 in the cost calculating unit 300B calculates the first cost L_e(I) for evaluating the estimation accuracy of the edge image estimating layer 210B using the correct edge image and the estimated edge image.

Next, the cost calculating unit 300B executes second cost calculation processing (step ST142).

In the second cost calculation processing, the second cost calculating unit 320 in the cost calculating unit 300B calculates the second cost L_g(P) (=|P−P¹|²) for evaluating the estimation accuracy of the geometric parameter estimating layer 220 using the correct geometric parameter and the estimated geometric parameter.

Next, the cost calculating unit 300B executes combined cost calculation processing (step ST143).

In the combined cost calculation processing, the combined cost calculating unit 330 of the cost calculating unit 300B calculates a cost obtained by combining the first cost L_e(I) and the second cost L_g(P). Specifically, the combined cost calculating unit 330 calculates the sum of the value of the first cost L_e(I) and the value obtained by multiplying the value of the second cost L_g(P) by the weight λ_g as the combined cost L(I, P).

When the combined cost calculating unit 330 outputs the combined cost L(I, P) including the first cost L_e(I), the second cost L_g(P), and the weight λ_g to the model parameter updating unit 400B, the cost calculating unit 300B ends the cost calculation processing.

The description returns to the processing illustrated in FIG. 11.

The image segmentation device 20 executes model parameter update processing (step ST260).

In the model parameter update processing, the model parameter updating unit 400B in the image segmentation device 20 updates the model parameter in the neural network of the edge estimating unit 200B using the cost (see Expression (4)) calculated by the cost calculating unit 300B.

The model parameter updating unit 400B optimizes and outputs a model parameter in the neural network in such a way as to reduce the cost (see Expression (4)) calculated by the cost calculating unit 300B.

Specifically, the model parameter updating unit 400B calculates the model parameter in such a way as to reduce the cost (see Expression (4)) using a known method such as an error back propagation method or a stochastic gradient descent (SGD) method, and optimizes the model parameter in the neural network.

The model parameter updating unit 400B causes each optimized model parameter to be stored in the storage unit (not illustrated).

After executing the model parameter update processing, the image segmentation device 20 ends one learning loop processing (step ST270) and starts the next learning loop processing (step ST210). The image segmentation device 20 can acquire the model parameter for edge estimation specialized for the edge estimation of the geometric shape by repeating the learning processing for the number of all sets of the learning data (n sets from 1000-1 to 1000-n).

Note that, in the description, learning (online learning) using one set of learning data at a time has been described, but a configuration may be employed in which mini-batch learning or batch learning is performed in which a plurality of sets is processed at a time.

When it is determined not to execute the learning processing (step ST200 “NO”), the image segmentation device 20 proceeds to the normal segmentation processing (segmentation processing of estimating an edge of a target image as illustrated in steps ST310 to ST340).

The image segmentation device 20 executes image acquisition processing (step ST310).

In the image acquisition processing, the image acquiring unit 500 of the image segmentation device 20 acquires a target image that is a processing target of the normal segmentation processing. The image acquiring unit 500 outputs the acquired target image to the edge estimation processing.

The image segmentation device 20 executes edge estimation processing (step ST320).

In the edge estimation processing, when a target image that is a processing target of the normal segmentation processing is input to the edge estimating unit 200B of the image segmentation device 20, the image segmentation device 20 executes estimation result output processing (step ST330).

In the estimation result output processing, the estimation result output unit 600 of the image segmentation device 20 outputs the estimated edge image output by the edge estimating unit 200B.

The estimation result output unit 600 can output, as an estimation result, an estimated edge image indicating an edge having a shape close to the geometric shape indicated in the correct edge image of the learning data by the edge estimating unit 200B after learning by the learning processing.

The image segmentation device 20 determines whether to end the normal segmentation processing (step ST340).

When it is determined not to end the normal segmentation processing (step ST340 “NO”), the image segmentation device 20 repeats the processing from the processing of step ST310.

When it is determined to end the normal segmentation processing (step ST340 “YES”), the image segmentation device 20 ends the series of processing.

The edge estimating unit 200B after learning in which learning by the configuration of the present disclosure is performed outputs an estimated edge image 2200 in which an edge estimated from an input target processing image 2100 indicates the original shape (geometrical shape such as a linear shape, an elliptical shape, a circular shape, or a quadratic curve shape) and a geometric parameter 2210 related to the shape of the estimated edge, similarly to the description already given with reference to FIG. 4B.

The image segmentation device of the present disclosure is configured as follows.

“An image segmentation device including:
an image acquiring unit to acquire a target image as a processing target; an edge estimating unit including a neural network to output an estimated edge image by inputting the target image to the neural network; and an estimation result output unit to output the estimated edge image output by the edge estimating unit, the image segmentation device including:
a learning data acquiring unit to acquire learning data that is a combination of a learning image, a correct edge image indicating a correct edge of the learning image, and a correct geometric parameter related to a shape of the correct edge;
the edge estimating unit to output an estimated edge image indicating an estimated edge of the learning image and an estimated geometric parameter related to a shape of the estimated edge by inputting the learning image to the neural network;
a cost calculating unit to calculate a cost for evaluating estimation accuracy by the edge estimating unit by using the correct edge image, the correct geometric parameter, the estimated edge image, and the estimated geometric parameter; and
a model parameter updating unit to optimize and update a model parameter in the neural network by using the cost calculated by the cost calculating unit.”

Thus, the present disclosure has an effect that an image segmentation device that improves estimation accuracy of image segmentation can be provided.

Furthermore, the present disclosure achieves an effect similar to the effect of each of the learning devices by applying each configuration of the above learning device.

The image segmentation device of the present disclosure is further configured as follows.

“An image segmentation device including:
an image acquiring unit to acquire a target image as a processing target; an edge estimating unit including a neural network to output an estimated edge image by inputting the target image to the neural network; and an estimation result output unit to output the estimated edge image output by the edge estimating unit, in which
by a learning device, by inputting a learning image to the neural network of the edge estimating unit by using the learning data that is a combination of the learning image, a correct edge image indicating a correct edge of the learning image, and a correct geometric parameter related to a shape of the correct edge, an estimated edge image indicating an estimated edge of the learning image and an estimated geometric parameter related to a shape of the estimated edge are output, a cost for evaluating estimation accuracy by the edge estimating unit is calculated by using the correct edge image, the correct geometric parameter, the estimated edge image, and the estimated geometric parameter, and a model parameter in the neural network of the edge estimating unit is updated by using the calculated cost.”

Thus, the present disclosure has an effect that an image segmentation device that improves estimation accuracy of image segmentation can be provided.

Furthermore, the present disclosure achieves an effect similar to the effect of each of the learning devices by updating the model parameter using each configuration of the above learning device.

Here, a hardware configuration for implementing the functions of the present disclosure will be described.

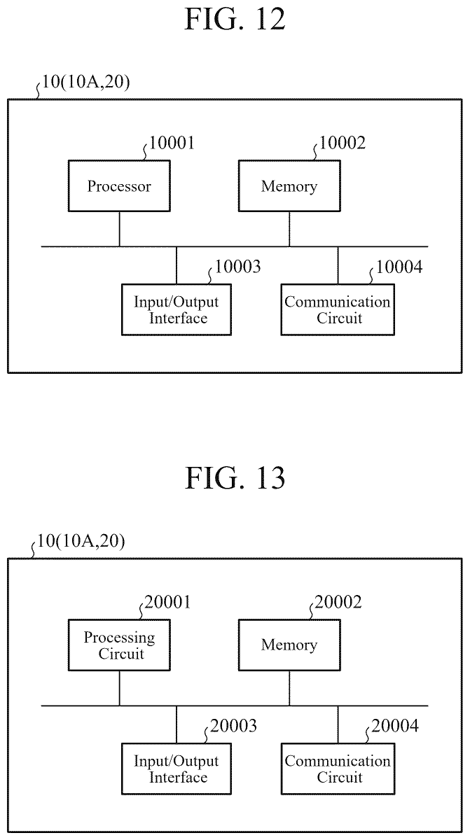

FIG. 12 is a diagram illustrating a first example of a hardware configuration for implementing the function according to the present disclosure.

FIG. 13 is a diagram illustrating a second example of a hardware configuration for implementing the function according to the present disclosure.

The learning device 10 or 10A or the image segmentation device 20 of the present disclosure is implemented by hardware as illustrated in FIG. 12 or 13.

As illustrated in FIG. 12, the learning device 10 or 10A or the image segmentation device 20 includes, for example, a processor 10001, a memory 10002, and a communication circuit 10004.

The processor 10001 and the memory 10002 are mounted on a computer, for example.

The memory 10002 stores a program for causing the computer to function as the learning data acquiring units 100, 100A, and 100B, the image selecting unit 110, the edge image selecting unit 120, the geometric parameter selecting unit 130, the edge estimating units 200, 200A, and 200B, the cost calculating units 300, 300A, and 300B, the first cost calculating unit 310, the second cost calculating unit 320, the combined cost calculating unit 330, the model parameter updating units 400, 400A, and 400B, the image acquiring unit 500, the estimation result output unit 600, and the control unit (not illustrated). When the processor 10001 reads and executes the program stored in the memory 10002, the functions of the learning data acquiring units 100, 100A, and 100B, the image selecting unit 110, the edge image selecting unit 120, the geometric parameter selecting unit 130, the edge estimating units 200, 200A, and 200B, the cost calculating units 300, 300A, and 300B, the first cost calculating unit 310, the second cost calculating unit 320, the combined cost calculating unit 330, the model parameter updating units 400, 400A, and 400B, the image acquiring unit 500, the estimation result output unit 600, and the control unit (not illustrated) are implemented.

Further, a storage unit that is not illustrated is implemented by the memory 10002 or another memory that is not illustrated. Further, in a case where the learning device 10 or 10A or the image segmentation device 20 includes a storage unit (not illustrated) that stores at least one of learning data, a model parameter, an estimated edge image, or an estimated geometric parameter, the storage unit (not illustrated) is implemented by the memory 10002 or another memory (not illustrated).

Further, a communication unit (not illustrated) is implemented by the communication circuit 10004.

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magneto-optical disk.

The processor 10001 and the memory 10002 or the communication circuit 10004 are connected in a state in which data can be transmitted to each other. Further, the processor 10001 and the memory 10002 or the communication circuit 10004 are connected in a state in which data can be mutually transmitted with other hardware via an input/output interface 10003.

Alternatively, the functions of the learning data acquiring units 100, 100A, and 100B, the image selecting unit 110, the edge image selecting unit 120, the geometric parameter selecting unit 130, the edge estimating units 200, 200A, and 200B, the cost calculating units 300, 300A, and 300B, the first cost calculating unit 310, the second cost calculating unit 320, the combined cost calculating unit 330, the model parameter updating units 400, 400A, and 400B, the image acquiring unit 500, the estimation result output unit 600, and the control unit (not illustrated) may be implemented by a dedicated processing circuit 20001 as illustrated in FIG. 13.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, a storage unit that is not illustrated is implemented by a memory 20002 or another memory that is not illustrated.

The memory 20002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magneto-optical disk.

Further, a communication unit (not illustrated) is implemented by a communication circuit 20004.

The processing circuit 20001 and the memory 20002 or the communication circuit 20004 are connected in a state in which data can be transmitted to each other. Further, the processing circuit 20001, the memory 20002, and the communication circuit 20004 are connected in a state in which data can be mutually transmitted with other hardware via an input/output interface 20003.

Note that the functions of the learning data acquiring units 100, 100A, and 100B, the image selecting unit 110, the edge image selecting unit 120, the geometric parameter selecting unit 130, the edge estimating units 200, 200A, and 200B, the cost calculating units 300, 300A, and 300B, the first cost calculating unit 310, the second cost calculating unit 320, the combined cost calculating unit 330, the model parameter updating units 400, 400A, and 400B, the image acquiring unit 500, the estimation result output unit 600, and the control unit (not illustrated) may be implemented by different processing circuits, or may be collectively implemented by a processing circuit.

Alternatively, some of the functions of the learning data acquiring units 100, 100A, and 100B, the image selecting unit 110, the edge image selecting unit 120, the geometric parameter selecting unit 130, the edge estimating units 200, 200A, and 200B, the cost calculating units 300, 300A, and 300B, the first cost calculating unit 310, the second cost calculating unit 320, the combined cost calculating unit 330, the model parameter updating units 400, 400A, and 400B, the image acquiring unit 500, the estimation result output unit 600, and the control unit (not illustrated) may be implemented by the processor 10001 and the memory 10002, and the remaining functions may be implemented by the processing circuit 20001.

Note that the present disclosure can freely combine the respective embodiments, modify any component of the respective embodiments, or omit any component of the respective embodiments within the scope of the disclosure.

### INDUSTRIAL APPLICABILITY

A learning device, a learning method, and an image segmentation device according to the present disclosure can improve estimation accuracy of image segmentation, and thus are suitable for use in an image recognition system using image segmentation.

### REFERENCE SIGNS LIST

10, 10A: learning device, 20: image segmentation device, 100, 100A, 100B: learning data acquiring unit, 110: image selecting unit, 120: edge image selecting unit, 130: geometric parameter selecting unit, 200, 200A, 200B: edge estimating unit, 210, 210B: edge image estimating layer, 220: geometric parameter estimating layer, 221: convolutional neural network (CNN) layer, 222: normalization layer, 223: activation layer, 224: pooling layer, 225: fully connected layer, 300, 300A, 300B: cost calculating unit, 310: first cost calculating unit, 320: second cost calculating unit, 330: combined cost calculating unit, 400, 400A, 400B: model parameter updating unit, 500: image acquiring unit, 600: estimation result output unit, 1000 (1000-1, 1000-2, . . . , 1000-n): learning data set (learning data), 1100: learning image, 1200: correct edge image, 1300: correct geometric parameter, 2100: segmentation target image, 2120: edge estimating unit, 2130: estimated edge image, 2200: estimated edge image, 2210: estimated geometric parameter, 10001: processor, 10002: memory, 10003: input/output interface, 10004: communication circuit, 20001: processing circuit, 20002: memory, 20003: input/output interface, 20004: communication circuit

1. A learning device comprising:
a processor; and
a memory storing a program, upon executed by the processor, to perform a process:
to acquire learning data that is a combination of a learning image, a correct edge image indicating a correct edge of the learning image, and a correct geometric parameter related to a shape of the correct edge;
using a neural network to output an estimated edge image indicating an estimated edge of the learning image and an estimated geometric parameter related to a shape of the estimated edge by inputting the learning image to the neural network;
to calculate a cost for evaluating estimation accuracy by using the correct edge image, the correct geometric parameter, the estimated edge image, and the estimated geometric parameter; and
to update a model parameter of the neural network by using the cost calculated.

2. The learning device according to claim 1, wherein the correct geometric parameter is a coefficient in a mathematical expression representing a two-dimensional geometric shape.

3. The learning device according to claim 2, wherein the correct geometric parameter is a coefficient in a mathematical expression representing a straight line.

4. The learning device according to claim 2, wherein the correct geometric parameter is a coefficient in a mathematical expression representing a circle.

5. The learning device according to claim 2, wherein the correct geometric parameter is a coefficient in a mathematical expression representing an ellipse.

6. The learning device according to claim 2, wherein the correct geometric parameter is a coefficient in a mathematical expression representing an n-th order curve (n≥2).

7. The learning device according to claim 1, wherein
the process uses:
an edge image estimating layer including a neural network to output an estimated edge image indicating an estimated edge of the learning image by inputting the learning image to the neural network; and
a geometric parameter estimating layer including a neural network to output an estimated geometric parameter related to a shape of the estimated edge indicated in the estimated edge image by inputting the estimated edge image to the neural network.

8. The learning device according to claim 7, wherein
the process includes:
to calculate a first cost for evaluating estimation accuracy of the edge image estimating layer using the correct edge image and the estimated edge image;
to calculate a second cost for evaluating estimation accuracy of the geometric parameter estimating layer using the correct geometric parameter and the estimated geometric parameter; and
to calculate a cost obtained by combining the first cost and the second cost.

9. A learning method comprising:
acquiring learning data that is a combination of a learning image, a correct edge image indicating a correct edge of the learning image, and a correct geometric parameter related to a shape of the correct edge;
using a neural network, outputting an estimated edge image indicating an estimated edge of the learning image and an estimated geometric parameter related to a shape of the estimated edge by inputting the learning image to the neural network;
calculating a cost for evaluating estimation accuracy by using the correct edge image, the correct geometric parameter, the estimated edge image, and the estimated geometric parameter; and
updating a model parameter of the neural network by using the cost calculated.

10. An image segmentation device comprising:
a processor; and
a memory storing a program, upon executed by the processor, to perform a process:
to acquire a target image as a processing target; using a neural network to output an estimated edge image by inputting the target image to the neural network; and
to output the estimated edge image output, the process including:
to acquire learning data that is a combination of a learning image, a correct edge image indicating a correct edge of the learning image, and a correct geometric parameter related to a shape of the correct edge;
to output an estimated edge image indicating an estimated edge of the learning image and an estimated geometric parameter related to a shape of the estimated edge by inputting the learning image to the neural network;
to calculate a cost for evaluating estimation accuracy by using the correct edge image, the correct geometric parameter, the estimated edge image, and the estimated geometric parameter; and
to optimize and update a model parameter of the neural network by using the cost calculated.

11. An image segmentation device comprising:
a processor; and
a memory storing a program, upon executed by the processor, to perform a process:
to acquire a target image as a processing target; using a neural network to output an estimated edge image by inputting the target image to the neural network; and to output the estimated edge image output, wherein
by a learning device, by inputting a learning image to the neural network by using the learning data that is a combination of the learning image, a correct edge image indicating a correct edge of the learning image, and a correct geometric parameter related to a shape of the correct edge, an estimated edge image indicating an estimated edge of the learning image and an estimated geometric parameter related to a shape of the estimated edge are output, a cost for evaluating estimation accuracy is calculated by using the correct edge image, the correct geometric parameter, the estimated edge image, and the estimated geometric parameter, and a model parameter of the neural network is updated by using the calculated cost.
